(19) United States
(12) Patent Application Publication
(10) Pub. No.: US 2011/0210942 A1
(43) Pub. Date: Sep. 1, 2011

(54) DISPLAY APPARATUS AND VENDING MACHINE

(75) Inventors: Yutaka KITAMORI, Kadoma City (JP); Tatsuya HOSOMI, Kawanishi City (JP); Yoshihide TAKAHASHI, Kyotanabe City (JP)

(73) Assignee: SANYO ELECTRIC CO., LTD., Osaka (JP)

(21) Appl. No.: 13/035,901

(22) Filed: Feb. 25, 2011

(30) Foreign Application Priority Data
Feb. 26, 2010 (JP) 2010-042165
Jul. 30, 2010 (JP) 2010-171565

(51) Int. Cl. G09G 3/36; G06F 3/045

(52) U.S. Cl. 345/174; 345/104

(57) ABSTRACT

A display apparatus has: a touch panel of a capacitance type; a detector which detects, as an environmental condition, at least one of temperature, humidity, and pressure; and an adjuster which adjusts the environmental condition based on the result of the detection. The adjuster varies the intensity of adjustment stepwise.

This application is based on Japanese Patent Application No. 2010-042165 filed on Feb. 26, 2010 and Japanese Patent Application No. 2010-171565 filed on Jul. 30, 2010, the contents of which are hereby incorporated by reference.

### BACKGROUND OF THE INVENTION

1. Field of the Invention

The present invention relates to a display apparatus provided with a touch panel, or to a vending machine provided with such a display apparatus.

2. Description of Related Art

Conventionally, touch panels are widely used as an interface in bank ATMs or railway ticket vending machines. Touch panels are available in a wide range of sizes from several inches to over 50 inches.

In the past, these displays provided with touch panels were mostly installed indoors, but recently they are installed outdoors or semi-outdoors such as at gas stations or in sight-seeing guide boards.

According to the operation principle, touch panels are classified into a resistive film type, a capacitance type, an ultrasonic type, an infrared type, etc. Since each type of the touch panels have advantages and disadvantages, the appropriate types should be selected for particular uses. As touch panels for 20 inches or larger displays installed outdoors or semi-outdoors, the capacitance type are widely used for example.

As disclosed in JP 2009-258903 A1 etc., the capacitance type touch panel has sensors which detect changes in capacitance are provided across the panel. The position touched by user's finger is determined based on the detected capacitance in each position of the panel.

Capacitance occurs where two conductors are arranged across a dielectric material. The magnitude of capacitance is given by formula (1) below.

C=E₀×E_{S}×S/d (1)

where

C represents the capacitance (F);

E₀ represents the dielectric constant of vacuum, which equals 8.854×10⁻¹² (F/m);

E_{S} represents the relative dielectric constant of the dielectric;

S represents the area of the conductors (m²); and

d represents the distance between the conductors (m).

Environmental conditions may affect the performance of a touch panel of the above capacitance type. For example, it may cause a false detection, mistakenly detecting that the finger is touched even though the finger is not actually touched.

One of the techniques to reduce such false detection is to control the temperature. JP-2009-296105 A1 discloses a display apparatus having a structure in which air is passed between a liquid crystal panel and a front glass using a fan. When such structure is adopted, the temperature of not only the liquid crystal panel but also the touch panel can be lowered, and thus false detections in the touch panel are expected to be reduced.

However, in such display apparatuses, if the rotation speed of the fan or the intensity of cooling changes drastically or rapidly, the offset in the capacitance may change abruptly. Thus, the deviation of the sensor's capacitance from its standard value (=the offset in capacitance) varies. Consequently, it may cause the false detection in the touch panel.

### SUMMARY OF THE INVENTION

According to the present invention, a display apparatus includes: a touch panel of a capacitance type; a detector which detects, as an environmental condition, at least one of temperature, humidity, and pressure; and an adjuster which adjusts the environmental condition based on the result of the detection, wherein the adjuster varies the intensity of adjustment stepwise.

### BRIEF DESCRIPTION OF THE DRAWINGS

FIG. 1 is an external view of a vending machine according to an embodiment of the invention;

FIG. 2 is a diagram illustrating the arrangement of a display apparatus in the vending machine.

FIG. 3 is a diagram illustrating a cooling mechanism according to an embodiment of the invention;

FIG. 4 is a block diagram showing the configuration of the vending machine;

FIG. 5 is a diagram showing the construction of a display apparatus according to an embodiment of the invention;

FIG. 6 is a diagram showing the construction of the display apparatus as seen from another direction;

FIG. 7 is a diagram showing the construction of the display apparatus as seen from yet another direction; and

FIG. 8 is a flow chart showing temperature adjustment operation.

### DETAILED DESCRIPTION OF PREFERRED EMBODIMENTS

The embodiment of the present invention is described below. The following embodiment regards to a vending machine or a display apparatus attached to the vending machine.

[Structure of the Vending Machine]

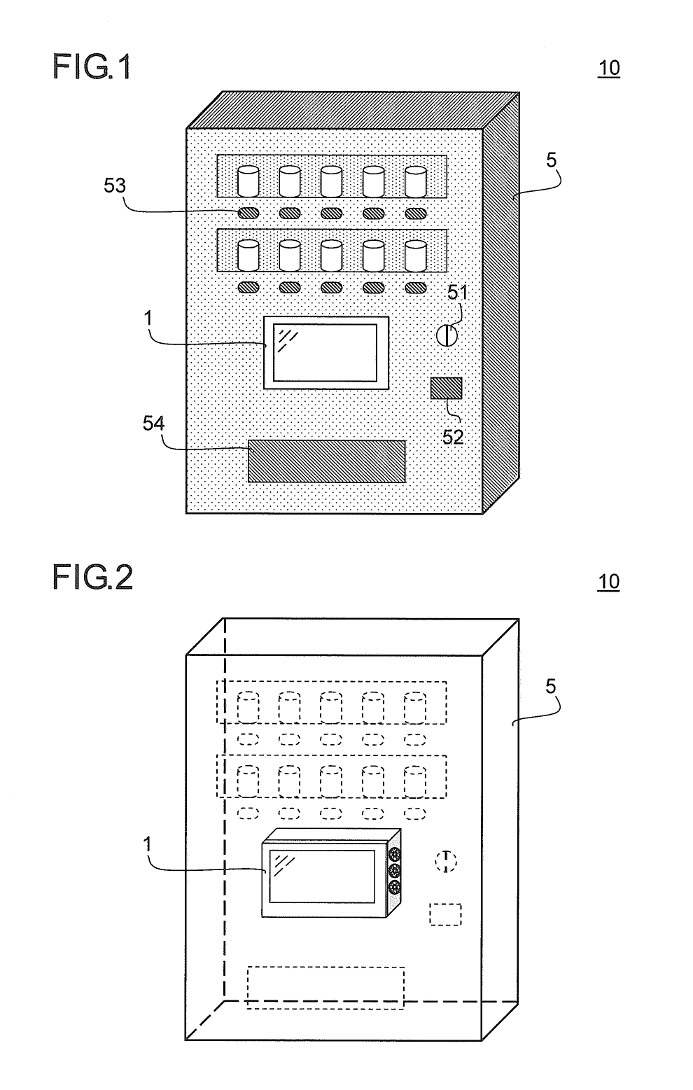

FIG. 1 is an external view of a vending machine 10. FIG. 2 is a diagram showing the arrangement of a display apparatus 1 in the machine 10. As shown in these diagrams, the display 1 is fitted to the body 5 of the machine 10.

[Structure of a Cooling Mechanism]

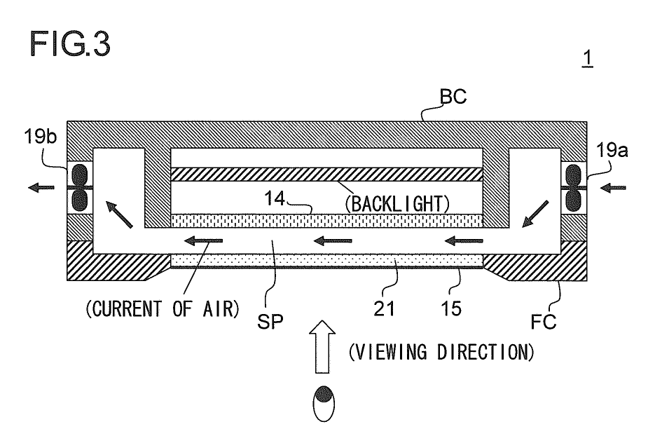

As shown in FIG. 3, the display 1 has a cooling mechanism which cools the display 1 itself. The cooling mechanism cools the display 1 by rotating fans 19 and thereby passes air from outside into the cabinet of the display 1.

When the display 1 is installed outdoors, a liquid crystal panel 14 is heated intensely by sunlight. Therefore, it is important to cool the panel 14, particularly the front-face side thereof.

To cool the liquid crystal panel 14 efficiently, the display 1 has a structure so that air is passed through a space (SP) between the liquid crystal panel 14 and a front glass 21 provided at the front-face side of the panel 14.

When the fans 19 rotate, air passes from inhaling fans 19a to exhaust fans 19b. As shown in FIG. 3, a touch panel 15 is adhered on the front-face side of the front glass 21. If the fans 19 rotate for purpose of cooling the liquid crystal panel 14, the temperature on the touch panel 15 changes precipitously. As a result, the offset of the touch panel 15 fluctuates, and a false detection in the panel 15 may occur. Accordingly, in the display 1, a control is performed so that the air flow produced by the fans is changed stepwise.

The body 5 is provided with product selection buttons 53 (a portion for which the user select a product to buy), a processing controller 55, a coin handling mechanism 56, a product transport mechanism 57, etc., and is box-shaped.

A CPU 55 performs various kinds of control processing.

The coin handling unit 56 handles coins, and includes, a coin inlet 51, a coin outlet, a coin transporter, a coin storage, and a coin sorter, etc.

The product transport unit 57 handles products sold by the machine 10, and has a product outlet 54, a product storage, and a product transporter, etc.

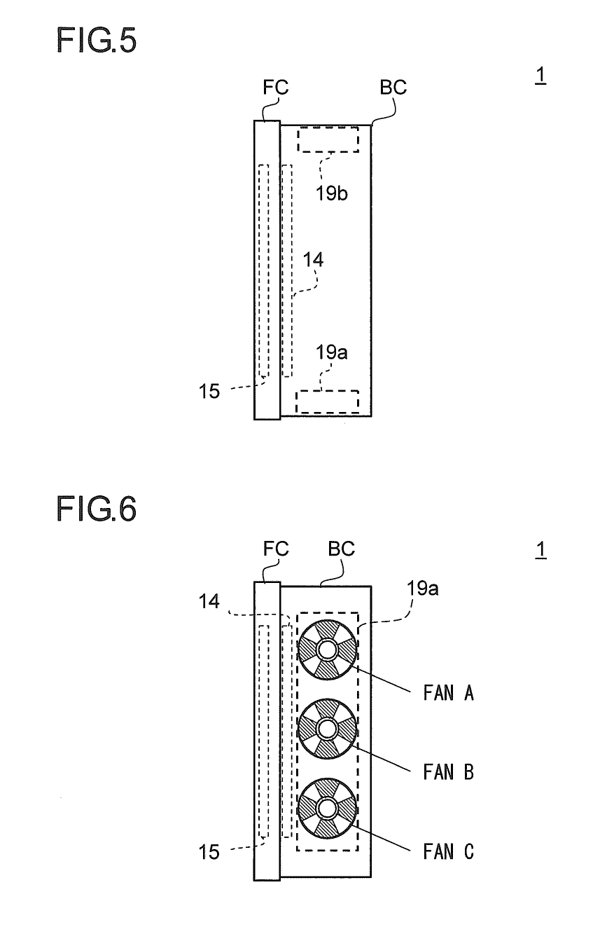

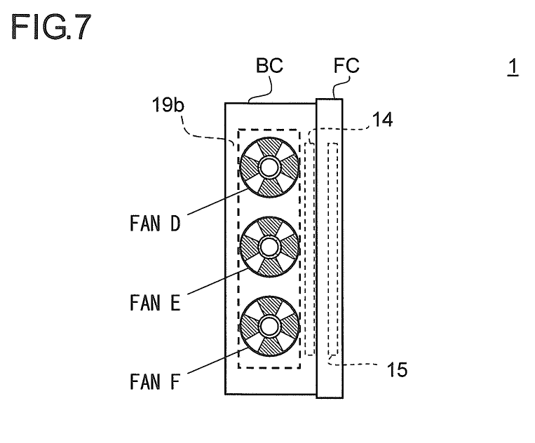

FIG. 5 is a diagram showing the structure of the display 1 seen from the top. FIG. 6 is a diagram showing the structure of the display 1 seen from the right side. FIG. 7 is a diagram showing the structure of the display 1 seen from the left side.

As shown in these figures, the display 1 has a housing made of front cabinet FC and a back cabinet BC. The liquid crystal panel 14 is arranged at the front-face side of the BC, and the touch panel 15 is arranged in the FC so that the touch panel 15 overlaps the liquid crystal panel 14. The inhaling fans 19a (fans A, B, and C) are arranged in one side of the BC, and the exhaust fans 19b (D, E, and F) are arranged in the other side of the BC.

The temperature inside the cabinet is affected by the atmospheric temperature at the installation site and the heat generated inside the display 1. Thus the temperature may vary in a wide range from 0 degrees Celsius or less, to 60 degrees Celsius or more.

[Processing Performed by the Vending Machine]

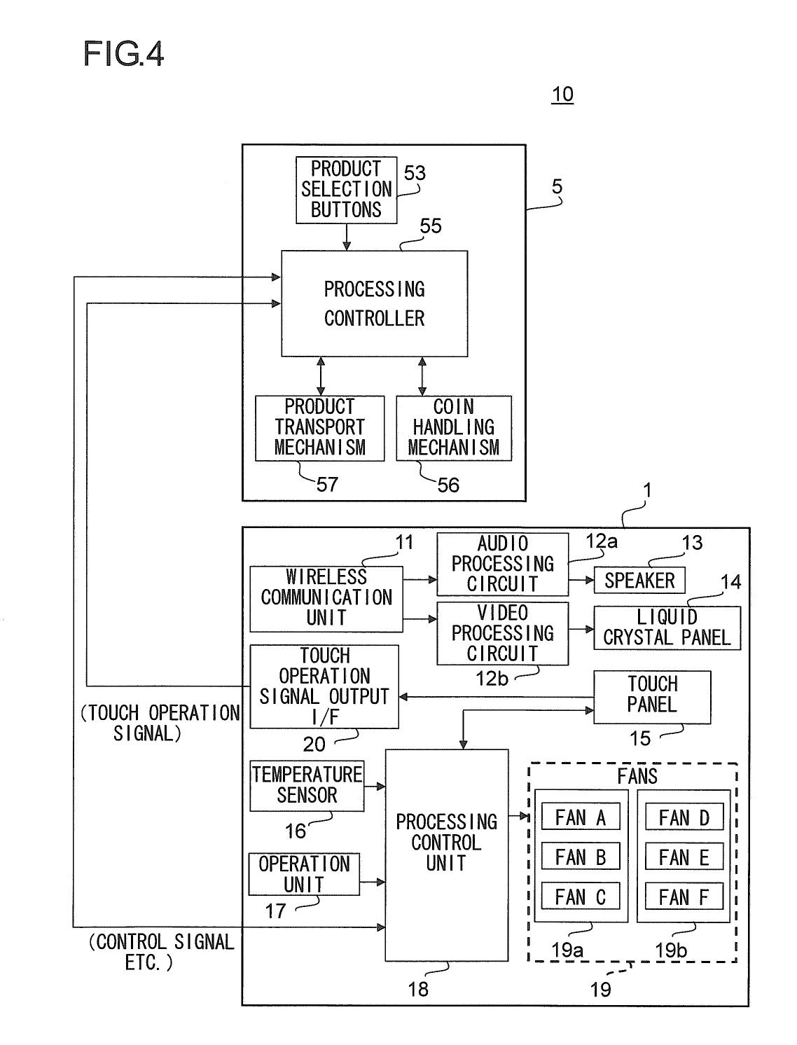

FIG. 4 is a block diagram showing the configuration of the machine 10. The major process performed by the machine 10 is “product selling process”, “video/audio output process”, “touch operation acceptance process”, “touch panel initialization process”, and “temperature adjustment process”.

The “product sale process” is a process for selling products based on demand from the user. This process is same as the process performed in common vending machines. This process is executed mainly by the processing controller 55 which controls the units 56 and 57.

The controller 55 counts the amount of money fed into the coin inlet 51. When one of the product selection buttons 53 is pressed, the controller 55 transports the selected product to the outlet 54.

The “video/audio output process” is a process for displaying an image and outputting sound based on video/audio signals received by a wireless communication unit 11.

The “touch operation acceptance process” is a process for accepting a touch operation made by the user on the touch panel 15. When the touch operation is made, the signal is fed to the processing controller 55 via a touch operation signal output I/F 20. I/F 20 is implemented as a USB interface for example.

Instead of pushing the button 53, a user can select a product also by a touch operation on the touch panel 15.

The “touch panel initialization process” is process for adjusting the threshold value of sensors provided over the touch panel 15 so as to stabilize the detecting function of the touch panel 15. Via the I/F 20, offset in capacitance is monitored continuously.

Based on the result of this monitoring, the unit 18 adjusts the threshold value of the sensors so as to cancel the offset.

The threshold value may be set at different values for the sensors at different places of the panel 15. Thereby, the detection can be performed correctly even when the offset is caused by dust or rain attached to the touch panel 15.

However, when this initialization process is performed too frequently, it may hamper the detection process. Accordingly, this initialization process is performed at certain time intervals, for example, for a period of ten and several seconds. In this case, when one-half of the period pass, the offset in capacitance is predicted, and the threshold value is adjusted so as to cancel the predicted offset.

[Temperature Adjustment Process]

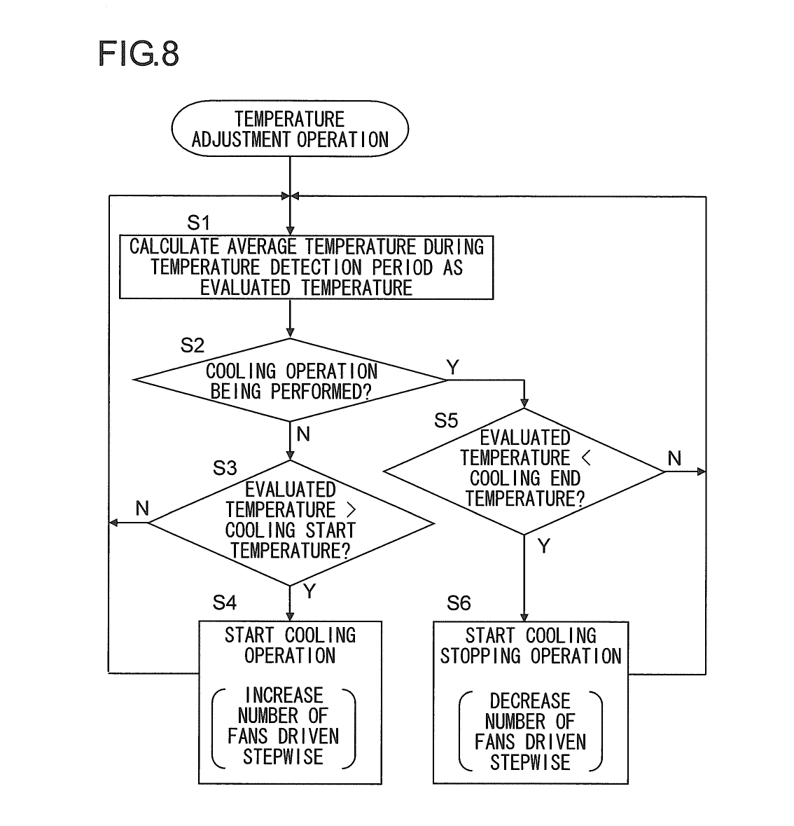

The temperature adjustment process is a process to adjust the temperature of the display 1 by driving the fans 19. This process is described below with reference to a flow chart in FIG. 8.

A processing control unit 18 continuously acquires the temperature information detected by a temperature sensor 16 and calculates the average of the temperature detected during the predetermined time period Ttemp as an evaluated temperature (step S1). Instead of the average temperature during Ttemp, the temperature at a predetermined time point may be adopted as the evaluated temperature.

Next, the unit 18 determines whether or not cooling is currently being performed (step S2). If cooling is not being performed (“N” at step S2), the unit 18 determines whether or not the evaluated temperature is higher than a predetermined cooling initiating temperature Temp1 (step S3).

When it is determined that the evaluated temperature is higher than Temp1 (“Y” at step S3), the unit 18 initiates the cooling process (step S4). When it is determined that the evaluated temperature is not higher than the Temp1 (“N” at step S3), the flow returns to step S1.

At step S5, the unit 18 determines whether or not the evaluated temperature is lower than a cooling terminating temperature Temp2. In this embodiment Temp2 is assumed to be lower than Temp1, but they may have an equal value.

When it is determined that the evaluated temperature is lower than Temp2 (“Y” at step S5), cooling terminating process begins (step S4). When it is determined that the evaluated temperature is not lower than Temp2 (“N” at step S5), the flow returns to step S1.

Next, the cooling operation at step S4 mentioned above is described specifically. When cooling operation is initiated, first, the unit 18 begins driving fans A and D only, out of the six fans A to F. A predetermined time thereafter (for example, 20 seconds thereafter), the unit 18 additionally drives fans B and E.

Another predetermined time (20 seconds) thereafter, fans C and F are additionally driven. As a result, all the fans 19 are being driven. Thereby, the display 1 increases the number of fans driven stepwise during the initiation of the cooling. Thereafter, all the fans are kept being driven until a cooling terminating process begins.

Next, the cooling terminating operation at step S6 mentioned above is described specifically. In the cooling terminating operation, first, the unit 18 terminates fans C and F, out of the six fans A to F. A predetermined time thereafter, the unit 18 additionally terminates fans B and E.

Another predetermined time thereafter, fans A and D is terminated. As a result, all of the fans 19 are not driving, and cooling operation is not being performed. Thereby, the display 1 reduces the number of fans driven stepwise during the cooling terminating process. This state is maintained thereafter until the cooling operation is newly started.

If the temperature detection period Ttemp mentioned above is set shorter than the period needed for the touch panel initialization process, the initialization of the touch panel is outpaced by the change in temperature caused by driving of the fans. Consequently, the accuracy of the touch panel initialization process may be determined. Accordingly, the temperature detection period Ttemp is set longer than (about three to five times) the period necessary for the touch panel initialization process.

As described above, when initiating or terminating the cooling, the display 1 changes the number of driving fans stepwise. Thereby, the abrupt change in the temperature inside the display 1 accompanied by the cooling operation is reduced.

Further, by a touch operation, the user can select content. The display 1 may be configured so that, when content is selected, the corresponding image or sound is replayed.

The embodiment of the invention specifically described above is in no way meant to limit the invention. The invention may be carried out with many variations and modifications made without departing from the spirit of the invention.

For example, for the purpose of changing the air flow, other method may be adopted. For example, the air flow may be changed stepwise, instead of by changing the number of fans driven, by changing the rotation speed of the fans stepwise.

In the embodiment described above the display apparatus is used in a form fitted to the vending machine 10, the display apparatus may be used in a form fitted to any other device than a vending machine.

In the embodiment described above, a touch panel 15 is adhered on the front-face side of the front glass 21, however, the panel 15 may be adhered on the rear-face side of the glass 21 instead.

What is claimed is:

1. A display apparatus comprising:
a capacitance type touch panel;
a detector which detects, as an environmental condition, at least one of temperature, humidity, and pressure; and
an adjuster which adjusts the environmental condition based on the result of the detection, wherein
the adjuster varies the intensity of adjustment stepwise.

2. A display apparatus comprising:
a liquid crystal panel;
a light-transmissive member arranged at the front-face side of the liquid crystal panel;
a touch panel arranged at the front-face side of the light-transmissive member; and
a generator which generates a current of air in a space between the liquid crystal panel and the light-transmissive member, wherein
the generator is driven so as to vary the intensity of the current of air stepwise.

3. The display apparatus according to claim 2,
wherein the generator has a plurality of fans, and varies the intensity of the current of air by varying the number of fans driven stepwise.

4. The display apparatus according to claim 2,
wherein the generator has a fan, and varies the intensity of the current of air by varying the rotation speed of the fan stepwise.

5. A vending machine comprising the display apparatus according to claim 2.
